(19) United States
(12) Patent Application Publication
(10) Pub. No.: US 2017/0334168 A1
(43) Pub. Date: Nov. 23, 2017

(54) Hybrid Adhesive System For Metal and Composite Assemblies

(71) Applicant: FORD GLOBAL TECHNOLOGIES, LLC, Dearborn, MI (US)

(72) Inventor: ALAN GEORGE DRY, Grosse Pointe Woods, MI (US)

(21) Appl. No.: 15/157,491

(22) Filed: May 18, 2016

(51) Int. Cl. B32B 7/12; C09J 5/04; C04B 35/52; B32B 15/04; B32B 18/00; C09J 5/00

(52) U.S. Cl. CPC B32B 7/12; B32B 18/00; C09J 5/00; C04B 35/52; B32B 15/043; C09J 5/04; B32B 2250/02; B32B 2255/06; B32B 2605/08

(57) ABSTRACT

A metal or composite component assembly includes a first metal or composite component, a second metal or composite component, and an adhesive layer arranged on an interface of the first and second components and bonding the first and second components. The adhesive layer comprises a fast-cure low-strength adhesive and a high-strength structural adhesive.

### TECHNICAL FIELD

The disclosure relates to a combination of adhesives applied to metal and/or composite components to form assemblies and a method of producing the assemblies.

### BACKGROUND

Reducing manufacturing cycle time has been a long-term goal in the automotive industry. Yet, achieving fast cycle times of about 60 s remains a challenge with respect to structural components and assemblies fit for load bearing applications. Typically, such assemblies are welded from a variety of components. Alternative adhesive joining of metal components for load bearing applications requires multiple production lines, holding fixtures, and large process inventories. As a result, the production cycle times range from several hours to several months for one component.

### SUMMARY

A method of producing a metal or composite component assembly is disclosed. The assembly includes a first metal or composite component, a second metal or composite component, and an adhesive layer. The adhesive layer is arranged on an interface of the first and second components and bonding the first and second components. The adhesive layer includes a fast-cure low-strength adhesive and a high-strength adhesive. The high-strength adhesive may cure at a greater temperature than the fast-cure adhesive. The high-strength adhesive may cure slower than the fast-cure adhesive. The fast-cure adhesive may be arranged in a plurality of areas spaced apart from each other within the layer. At least one of the areas may be about 10 mm in diameter. The plurality of areas may represent about 10% of the adhesive layer surface area. The fast-cure adhesive may bond the first and second components with a tensile strength of about 6.9 MPa measured according to ISO 6922 achieved within about 10 seconds after application at ambient temperatures. The high-strength adhesive may have a post-cure tensile strength greater than 30 MPa. At least one of the first and second components may include steel.

In another embodiment, a metal or composite assembly is disclosed. The assembly may include a first member having a structural contact area and an end portion and a second member. The second member may be adhesively joined to the first member with a first bond formed by a fast-cure low-strength adhesive between the end portion of the first member and the second member. Additionally, the second member may be adhesively joined to the first member with a second bond formed by a high-strength adhesive between the structural contact area of the first member and the second member. The assembly may be a suspension member assembly. The first and second members may include a same metal. At least the first member may include a carbon fiber composite. The high-strength adhesive may cure slower than the fast-cure low-strength adhesive.

In yet another embodiment, a process for forming a metal or composite assembly is disclosed. The process may include applying a fast-cure low-strength adhesive and a high-strength adhesive to a first component, a second component, or both. The process may further include pressing the second component onto the first component to form an assembly. Additionally, the process may include removing the assembly from a nest such that the fast-cure low-strength adhesive provides sufficient tack to keep the first and second components joined at least until the high-strength adhesive cures after removal of the assembly from the nest. A cycle time, relating to the time required of the process may be less than 60 seconds. The process may further include removing the assembly from the nest within about 10 seconds after the fast-cure low-strength adhesive application. The high-strength adhesive may be a slow-cure or high temperature-cure adhesive. The process may further include curing the high-strength adhesive in an oven for about 20 to 60 minutes at a temperature of about 160° C. The process may also include applying the fast-cure low-strength adhesive to a plurality of target areas large enough to provide a non-creeping, non-fracturing bond after the assembly is removed from a nest.

### BRIEF DESCRIPTION OF THE DRAWINGS

FIGS. 1A-1E depict schematically a series of manufacturing steps for production of an example metal or composite component assembly implementing a combination of different adhesives in accordance with one or more embodiments;

FIGS. 2A and 2B depict schematic top views of components having a surface covered with two types of adhesives;

FIG. 3A depicts a perspective view of an example seat back assembly having a number of individual members joined according to one or more embodiments;

FIGS. 3B and 3D show schematic outline section views of FIG. 3A;

FIG. 3C shows a detailed section view of FIG. 3B;

FIG. 3E shows a detailed section view of FIG. 3D;

FIG. 4 depicts a perspective view of an example seat structure with a number of reinforcing brackets adhesively joined to the seat structure;

FIG. 5 shows a perspective view of an example reinforcing bracket with adhesively joined reinforcing plates for automotive applications;

FIG. 6 shows a perspective view of an example front edge stamping adhesively joined to the lower side reinforcement.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except where expressly indicated, all numerical quantities in this description indicating dimensions or material properties are to be understood as modified by the word “about” in describing the broadest scope of the present disclosure.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Reference is being made in detail to compositions, embodiments, and methods of the present invention known to the inventors. However, it should be understood that disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention.

The description of a group or class of materials as suitable for a given purpose in connection with one or more embodiments of the present invention implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Fast cycle times, defined as the time required for a component to make its way through the manufacturing stage, are desirable in majority of industries, and the automotive industry is no exception. Yet, identifying ways of speeding up the cycle time may present a challenge with respect to certain assemblies such as load-bearing metal assemblies. Typically, the cycle time of certain metal assemblies may be as slow as one assembly per week or one per month. Such slow cycle time in turn requires greater storage capacity, multiple production lines, large in-process inventories, and limits the production volume.

Commonly, metal assemblies including structural members are joined by welding which provides sufficient structural integrity to the assembly. But welding presents a number of disadvantages such as deviations in shape due to welding stresses, thermal requirements of the process, and overall high complexity of the welding operation. Additionally, providing a reliable corrosion protection and maintenance of the riveted or screwed connections of the welded assemblies may present a challenge, especially in humid environments. Thus, alternative methods of joining metal stamped parts have been developed. Among the alternatives are methods including joining vehicle components and subassemblies by adhesion. Yet, most adhesives require a gap width and have long curing times before the adhesives join individual members with sufficient strength that allows handling, transportation, machining, etc. The long curing times of adhesives which are structurally suitable for load bearing applications thus extend the cycle time. On the other hand, adhesives which cure relatively fast usually do not provide sufficient fatigue strength properties. Additionally, complex clamping systems holding the members to be joined are frequently set in place to hold the individual members until the adhesives cure.

A variety of combinations of adhesives have been proposed to join structural members. For example, a hot melt adhesive curing at temperatures of 300° C.-400° C. and a room temperature curing adhesive are disclosed in U.S. Pat. No. 3,971,688. The hot melt adhesive provides an initial bond, and the room temperature curing adhesive provides high strength bond. Yet, the assembly cures slowly over a period of time at room temperatures. Thus, the cycle time is long, and clamping is required to provide sufficient pressure before the assembly completely cures.

Thus, there is a need for a method of producing component assemblies for load-bearing, shock carrying applications having a cycle time less than 60 seconds. Additionally, it would be desirable to provide a method not requiring complex fixtures and clamps necessary hold the assembly which would further shorten the cycle time as clamps would not have to be installed and subsequently removed from the assembly. It would be further desirable to provide a fully automated method which would eliminate the need for any manual intervention.

According to one or more embodiments, a method is disclosed which solves one or more problems described above. The method presents a hybrid process having a dual system of adhesives. The first adhesive is a fast-cure low-strength adhesive. The second adhesive is a high-strength adhesive. Both adhesives are applied to one or more components to be joined. The fast-cure adhesive activates at room temperature and joins the components with sufficient tack/sufficient strength to allow removal of the components as a green assembly from the assembly nest. The green assembly is then placed in an oven in which the high-strength adhesive cures within several minutes with sufficient strength to render the assembly suitable for load bearing, shock carrying applications. The cycle time of the operation from the time of placement of the first component within the nest to the removal of the green assembly from the nest is within 60 seconds. The cured assembly is then produced within several minutes.

The first adhesive is referred to as a fast-cure low-strength adhesive. The fast-cure, rapid cure, or rapid bonding relates to the first adhesive achieving a bond adequate to enable transport of the green assembly from the nest, repositioning, and otherwise handling the green assembly. The rapid cure or rapid bonding may mean that the achieved bond strength is about 10%, 20%, 30%, or more of the theoretically achievable bond strength of the adhesive. For example, the fast-cure indicates that the fast-cure low-strength adhesive may cure rapidly within about 10 seconds after application to a surface.

The cure may be complete within 1 to 60 seconds, 2 to 10 seconds, 20 to 45 seconds, after application of the first adhesive to a surface. Alternatively still, the rate of cure may be up to 240 seconds or more. The cure rate is substrate-dependent and relates to the time required to develop shear strength of 0.1 N/mm². For example, the first adhesive may cure within 1 to 2 seconds on a composite substrate while 2 to 10 seconds on a first metal substrate, or 20 to 45 seconds on a second metal substrate which has a different composition than the first metal. The rate of cure may further depend on the bond gap, relative humidity, the like, or a combination of conditions. To accelerate the rate of cure, an activator may be applied to the surface to be bonded. The activator may be acetone-based.

The cure may be initiated by a variety of methods such as heat, pressure, UV light, moisture, the like, or a combination thereof. The first adhesive may cure at ambient temperatures of about 18° C. to 25° C. (68° F. to 77° F.) at about 50% humidity. The first adhesive may cure at ambient pressure of about 1.01325 bar (14.7 psi). Alternatively, the first adhesive may cure at lower of higher temperature, humidity, and/or pressure such that the temperature, humidity, and/or pressure of the area where the production takes place initiates and/or enables cure of the first adhesive. The temperature suitable for application of the first adhesive to a surface may be ambient or different temperature.

The low-strength adhesive relates to the first adhesive having a relatively low tensile sheer strength of about 0.5 MPa to 24 MPa or more, 2 MPa to 10 MPa or more, or 5 MPa to 7 MPa or more, measured according to ISO 6922. Tensile strength of less than about 0.5 MPa is also contemplated. The low-strength adhesive may join a first and second component with a tensile strength within the ranges named above (about 0.5 MPa to 24 MPa or more, 2 MPa to 10 MPa or more, or 5 MPa to 7 MPa or more, measured according to ISO 6922) to provide a sufficient tack to enable removal of the joined first and second components from the nest. Sufficient tack refers to such tensile sheer strength that enables handling and/or transportation of the joined components within about 10 s after application of the low-strength adhesive.

The second adhesive may be a high strength structural adhesive engineered to provide sufficiently strong bond between various substrates to carry structural load such as having a post-cure tensile sheer strength of more than about 24 MPa to 90 MPa or more, 30 MPa to 80 MPa or more, or 40 MPa to 50 MPa or more, and Young modulus of about 1,400 MPa or more. Just as with the first adhesive, the second adhesive may be initiated by a variety of methods such as heat, pressure, UV light, moisture, the like, or a combination thereof.

In at least one embodiment, the second adhesive may be a high-temperature cure adhesive. The second adhesive may thus cure at higher temperature than the first adhesive. Yet, the temperature required for curing of the second adhesive is lower than a temperature which would cause destruction of the first adhesive. Alternatively, the cure temperature of the second adhesive may cause at least partial destruction of the first adhesive. The second adhesive may cure at temperatures of about 100° C. to 300° C. (212° F. to 572° F.), 120° C. to 250° C. (248° F. to 482° F.), 150° C. to 190° C. (302° F. to 374° F.). Higher or lower cure temperatures are contemplated. A suitable application temperature may be ambient temperature named above or a temperature between about 20° C. to 50° C. (68° F. to 122° F.) or more.

The second adhesive may require longer time to cure than the first adhesive. For example, the second adhesive may cure within about 1 to 60 minutes, about 5 to 50 minutes, about 10 to 30 minutes. Alternatively still, the second adhesive may cure for more than 60 minutes such as up to about 24 hours. Yet, it is desirable that the entire assembly cures within several minutes such that the assembly achieves sufficient strength for immediate handling, transportation, and further manufacturing within the disclosed cure time.

The first and second adhesives may be a one component or a two component adhesive. While the composition of the first and second adhesive differs, the first and second adhesive may be based on the same or different class of chemicals such as epoxy, acrylates such as methacrylate, cyanoacrylates such as ethyl cyanoacrylate, silicones, the like, or a combination thereof. At least one of the adhesives may be solvent-based or be solvent-free. The adhesives may include additives such as tackifing resins such as rosins and their derivatives; terpenes and modified terpenes; aliphatic, cycloaliphatic, and aromatic resins, the like or a combination thereof. The adhesive may also include plasticizers such as benzoates including 1,4-cyclohexane dimethanol dibenzoate, glyceryl tribenzoate, or pentaerythritol tetrabenzoate, phthalates, paraffin oils, polyisobutylene, chlorinated paraffins, the like, or a combination thereof. The adhesives may include pigments which may be useful as a visual aid for quality control. Having different pigments for each kind of adhesive may be helpful when visually assessing the extent of adhesive application.

The components which may be joined by the method described herein may be metal or another high strength material. Exemplary metals to be joined may be a metal with or without alloying elements such as manganese, silicon, nickel, titanium, copper, chromium, and aluminum. The exemplary metals may include various types and grades of steel or aluminum. The method enables joining of different types of metals which may be otherwise difficult to join such as different aluminum alloys or different steel grades. Moreover, the method allows polymer-to-metal direct joining which provides further versatility with respect to material choices for different components. The high strength materials may include fiber-reinforced composites or other materials designed to provide weight reduction while increasing stiffness of the material, improving fatigue resistance, chemical resistance, or the like. While carbon fiber is a suitable reinforcing material due to high strength-to-weight and stiffness-to-weight ratio, other types of fiber are contemplated. Other suitable fiber may include aramid fiber, glass, basalt, natural fibers such as cotton, the like, or a combination thereof. The volume of the fiber within the composite may be up to 60 to 70%. The composite material may be thermoplastic or thermoset. The thermoset may include polyester resin, vinyl ester epoxy resin, phenolic resin, polyurethane, polyamide, polyimide, silicone, or another type of resin, and combinations thereof. Any other plastic that cures irreversibly when induced by heat, irradiation, or through a chemical reaction is contemplated. Exemplary materials may include glass-reinforced nylon or cotton fiber-reinforced nylon. The high strength materials may include materials having up to about 400 KSI (400,000 PSI) tensile strength and potentially having other beneficial properties such as low weight, low density, high corrosion resistance, low cost, the like, or a combination thereof.

The components may include one or more layers of sheet metal or other material described above. The components may have a variety of sizes, shapes, and configuration. Dimensions of the components may differ throughout each component. The dual hybrid adhesive system described herein is particularly suitable to join stamped sheet metal components or other parts which have a sufficiently large surface area to contact and overlap a surface area of another component so that the overall contact area has dimensions sufficient for adhesive joining. It is particularly advantageous when the individual components or at least their portions to be adhesively joined are in direct contact with each other. For example, a first component may nest within the contours of the second component or the first component and the second component may lay substantially flat against one another.

The components to be adhesively joined to form an assembly may be prepared by a variety of techniques such as bending, curling, decambering, drawing, hydroforming, incremental sheet forming, ironing, laser cutting, press brake forming, punching, roll forming, rolling, spinning, stamping, water jet cutting, wheeling, or a combination thereof.

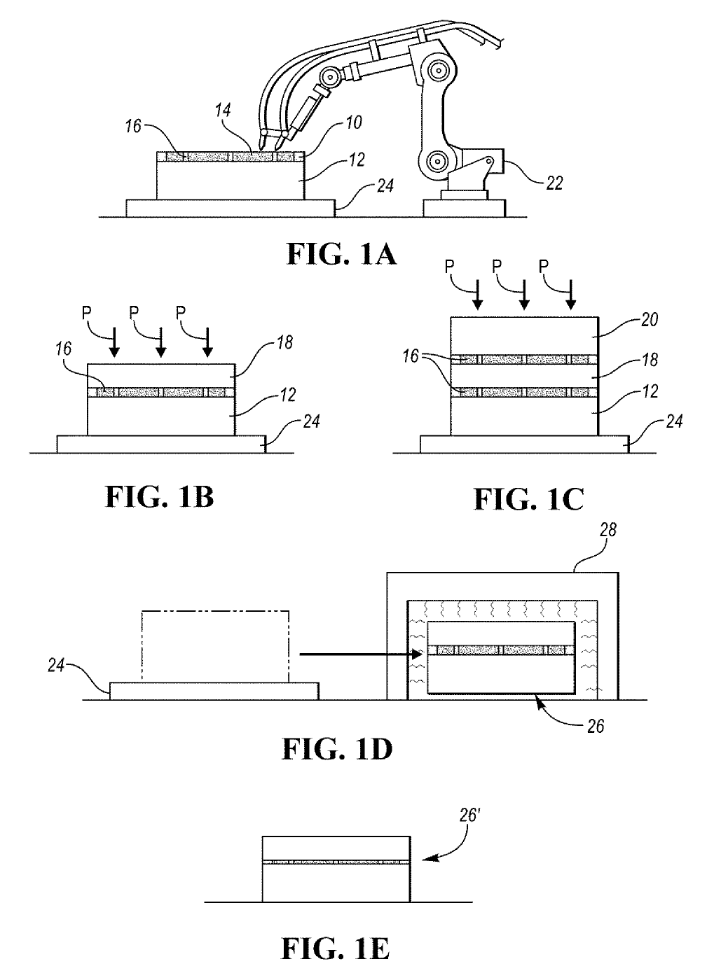

As FIG. 1A, depicts, the method includes a step of applying the fast-cure low-strength adhesive 10 onto a first component 12. The high-strength adhesive 14 is applied at the same or different time than the first adhesive 10. To decrease the cycle time, simultaneous application of both adhesives 10, 14 may be beneficial. But if the area to which the adhesives are being applied is relatively large, simultaneous application may cause premature curing of the fast-cure adhesive 10. Thus, it may be beneficial in at least some embodiments to apply the high-strength adhesive 14 before applying the fast-cure adhesive 10. The adhesives 10, 14 may form a layer 16. The layer 16 may be continuous or discontinuous. The layer 16 may include gaps.

The method further includes applying a second component 18 onto the layer 16, as FIG. 1B illustrates. FIG. 1C discloses an alternative embodiment in which more than two components are used. While FIG. 1C depicts three individual components, multilayer assemblies of up to 10 or more components are contemplated. In such embodiments, at least a third component 20 is connected to the first and second components 12, 18 via an additional layer 16 including the first and second adhesives 10, 14. After the additional components are placed onto the adhesive layer 16, pressure is applied onto the components to ensure a complete wetting out or coverage of the component surfaces to be bonded with the adhesives 10, 14. The pressure should be applied with such force and under such angle as to provide a full density bond line without the presence of shear stress in the adhesive layer 16. The pressure may be applied temporarily while the components are within the nest 24 and subsequently released after the fast-cure adhesive 10 cures such that no additional pressure has to be applied to the components. The nest 24 relates to an opened-top area where individual components are positioned relatively to each other such that assemblies are built. Alternatively, pressure may be applied during later processing and in the curing oven 28. The amount of pressure to be applied depends on a plurality of factors such as the materials used, the dimensions and shape of the components, length of compression, the like, or a combination thereof. For example, pressure which may be applied to the components may be about 0.1 MPa to about 100 MPa. Lower and higher pressure is contemplated. In at least one embodiment, the components are not exposed to higher pressure than ambient pressure throughout the process.

The entire process or portions thereof may be performed without any automation, for example to decrease costs associated with the process. Alternatively, at least a portion of the process may be automated. The components may be applied by one or more robots. The adhesives may be applied robotically by one or more robots 22 programmed to apply the adhesives in a variety of patterns. The robots 22 may be equipped with adhesive supplies and arms having applicators capable of applying the adhesives. Alternatively, the adhesives may be applied manually. One or more adhesives 10, 14 may be applied to each component 12, 18, 20. Alternatively, at least one adhesive 10 or 14 may be applied to only some of the components 12, 18, 20. For example, both adhesives 10, 14 may be applied to the first component 12 and no adhesive is applied to the second component 18. In another embodiment, the first adhesive 10 may be applied to the first component 12, and the second adhesive 14 may be applied to the second component 18. Alternatively still, no adhesive is applied to the first and third components 12, 20, while the first and second adhesives 10, 14 are applied to surfaces of the second component 18 such that each surface to be joined with the first and third components 12, 20 contains both the adhesives 10, 14.

After the pressure is applied to the components, the fast-cure adhesive 10 will set and begin its curing process while the high-strength adhesive 14 remains in its non-activated or inert state. The method further includes removing the components 12, 18, 20, now forming a green assembly 26, from the nest 24 as soon as the fast-cure adhesive 10 cures. Since the fast-cure adhesive 10 provides a bond which is sufficiently strong to join the components 12, 18, 20 for handling and/or transportation, the green assembly 26 may be removed from the nest 24 which may be utilized for formation of the next assembly. The method thus includes removing the green assembly 26 from the nest 24 within about 30 s, 40 s, 50 s, 60 s, 70 s, 80 s 90 s, 120 s, 240 s, or more from the time the first component 12 was placed in the nest 24. The green assembly 26 is capable of passing through a number of processes without separation into individual components 12, 18, 20 prior to placement into the oven 28.

The method includes placing the green assembly 26 into an oven 28, which is schematically depicted in FIG. 1D. The oven 28 may be any processing oven capable of curing the high-strength adhesive 14. For example, the oven 28 may be a paint oven conventionally utilized during processing through which the joined components are to pass. Thus, an already-existing step of the production line is utilized to finish curing of the green assembly 26, and another oven specifically designed for curing does not have to be provided. Yet, the curing temperature of the high-strength adhesive 14 should not be high enough to cause elimination of structural integrity of the fast-cure adhesive 10 prior to the high-strength adhesive 14 achieving sufficient strength to bond the components. The method includes keeping the green assembly 26 exposed to the desirable elevated curing temperature for a period of time sufficient to provide a bond strong enough for load-bearing applications. The period of time differs depending on the type of the high-strength adhesive 14 used. The period of time may be about 1, 2, 3, 4, 5, 6, 7, 8, 9, 10, 15, 20, 25, 30, 35, 40, 45, 50, 55, 60 minutes, 2, 3, 4, 5, 6, 7, 8, 9, 10, 15, 20 hours, or more. The green assembly 26 becomes a cured assembly 26′ once the high-strength adhesive 14 cures. In at least one embodiment, keeping the cured assembly 26′ in the oven 28 for an additional period of time is contemplated. The green assembly 26 may be exposed to elevated pressure in the oven 28. The cured assembly 26′ may be then removed from the oven 28, as is depicted in FIG. 1E, and may be immediately used for load-bearing shock-carrying applications described herein.

In at least one embodiment, the green assembly 26 is not placed directly into the oven 28 after being removed from the nest 24. In such embodiments, the green assembly 26 may be joined to other parts or assemblies by adhesives or otherwise such that multi-layer assemblies are created. For example, a floor pan, structural component forming the trunk and rear bumper of the vehicle, structural components forming the front bumper of the vehicle, and the central body of the floor pan may be subject to their own subassembly according to the method disclosed herein, robotically removed from respective nests to another station, where they may be adhesively joined together to form a large assembly. Alternatively, the large assembly could be further united with top structural load-bearing components such as door pillars, roof, and the like. Once joined, the entire assembly would be transferred to the paint shop for paint application and curing in the oven 28.

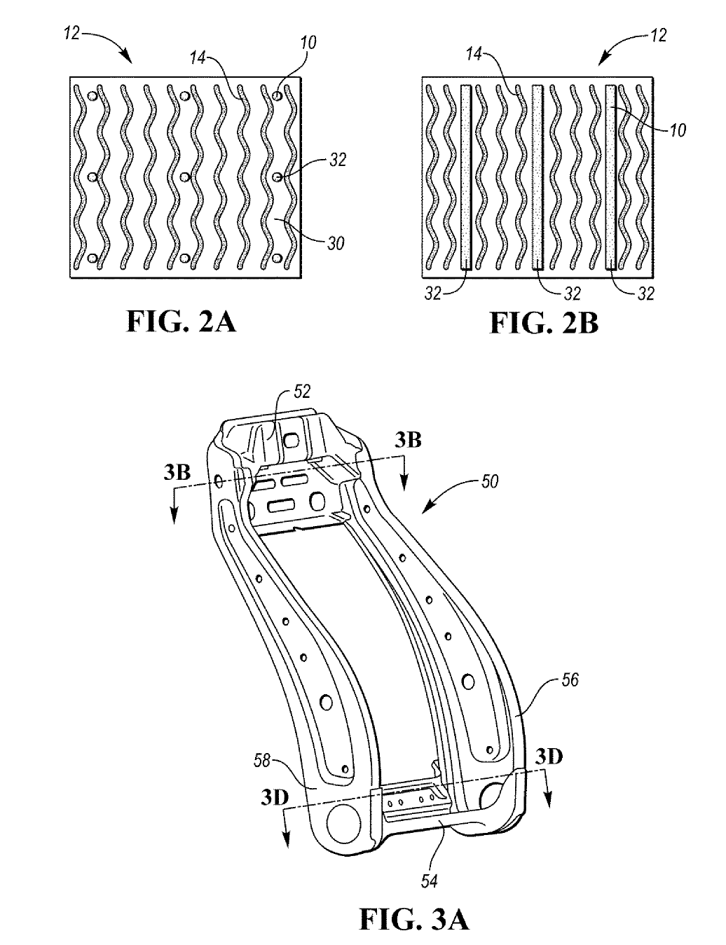

The bond site 30 may be prepared by the robotic application in a variety of patterns. Exemplary patterns are depicted in FIGS. 2A and 2B. For example, the high-strength adhesive 14 may be applied over the entire bond area 30 except a small number of target areas 32 into which a robot will apply the fast-cure adhesive 10, as is depicted in FIG. 2A. The target area 32 may have any shape, size, and configuration. The target area 32 may be circular, oval, rectangular, square, diamond, regular, irregular, symmetrical, asymmetrical, or the like. The spacing of the target areas relative to each other 32 may be regular, irregular, random, symmetrical, asymmetrical, or the like throughout the surface to be joined. For example, the target areas 32 may be located in at least two opposing corners of a component. The target areas 32 having the fast-cure adhesive 10 may be surrounded by the high-strength adhesive 14 on all sides, as is shown in FIG. 2A. Alternatively, the fast-cure adhesive 10 may be applied such that the fast-cure adhesive 10 forms a divider between at least two portions of the high-strength adhesive 14. Such embodiment is depicted in FIG. 2B, in which the target areas 32 form stripes separating a number of stripes of the high-strength adhesive.

The amount and dimensions of the target areas 32 may differ, depending on a specific application. The target areas 32 should be large and numerous enough to provide a bond of sufficient strength to enable handling of the green assembly 26 within up to 10 seconds, 60 seconds, 240 seconds, or more after application of the fast-cure adhesive 10. The target areas 32 should be large enough to provide a non-creeping, non-fracturing interface during normal in-process handling of the green assembly 26. The target area 32 may have a diameter d, which may be, for example, about 1 to 50 mm, 5 to 25 mm, 10 to 15 mm. Yet, the diameter d may be smaller or larger, depending on requirements of a particular application. The target areas 32 may cover about 0.5%, 1%, 2%, 3%, 5%, 10%, 15%, 20%, or 25% of the adhesive layer 16 surface area.

The adhesives 10 and 14 may be applied as a layer 16. The layer 16, the fast-cure adhesive 10, the high-strength adhesive 14, or a combination thereof may have a uniform or varying thickness. It is desirable to minimize the amount and dimensions of the target areas 32 such that the majority of the bond area will be joined with the high-strength adhesive 14. While the amount of the high-strength adhesive 14 applied to a component surface may be larger than the amount of the fast-cure adhesive 10, care has to be taken to assure that the high strength adhesive 14 does not cover the bond area reserved for application of the fast-cure adhesive 10.

The method may be used to produce a variety of assemblies to be utilized in a variety of industries including aerospace, automotive, marine, and other transportation applications where a need for short cycle time manufacture exists. Exemplary assemblies may include airframes, seat back assemblies, suspension members, pillars, side rails, roof rails, and other load-bearing shock-carrying applications capable of carrying loads of several thousand pounds, capable of withstanding impacts such as a minor rear end collision without structural damage, capable of absorbing energy in response to a front end collision, the like, or a combination thereof. Non-limiting exemplary types of vehicle which may utilize assemblies produced by the method described herein include land vehicles such as automobiles, buses, vehicles for transportation of goods, motorcycles, off-road vehicles, tracked vehicles, trains, amphibious vehicles, aircrafts, space crafts, watercrafts, or the like.

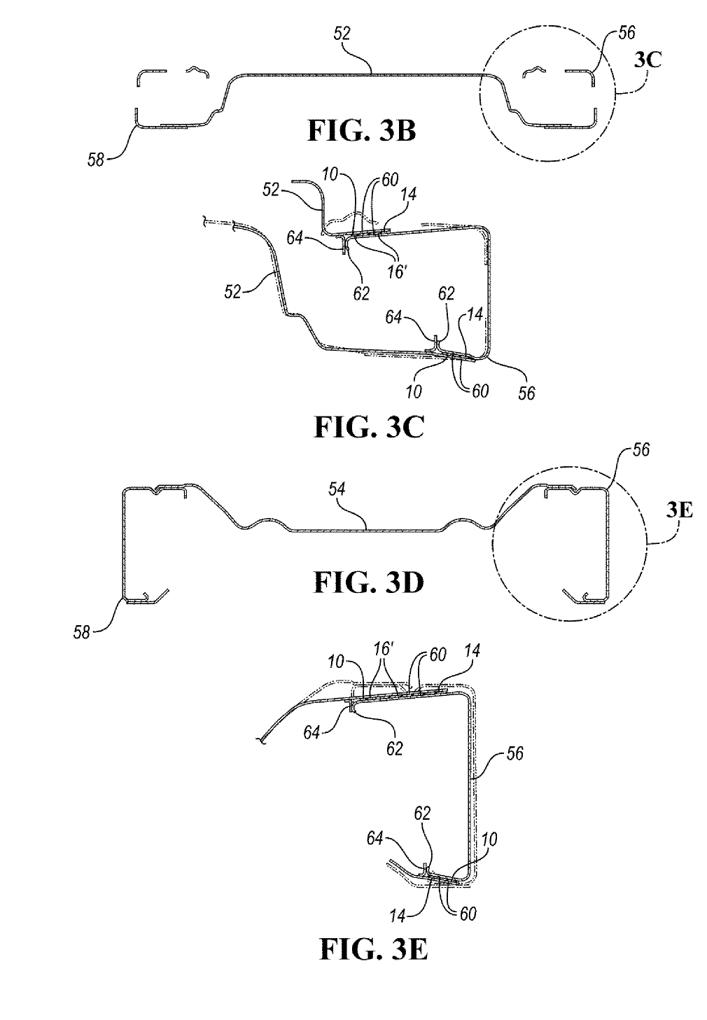

An example assembly, a seat back assembly 50, is depicted in FIG. 3A which shows a stamped steel seat back assembly 50 including four discreet parts which are typically welded together, but the hybrid adhesive method disclosed herein allows replacement of the welds with adhesive joints. FIG. 3A shows a perspective view of the seat back assembly 50 including a top cross member 52 connected to the lower cross member 54 via a left side member 56 and the right side member 58.

FIG. 3B depicts an outline of a section of the seat back assembly 50 including adhesive joints between the left and right side members 56, 58 and the top cross member 52. The shape of the members 52, 56, 58 may be modified to provide for optimal adhesive attachment of the side members 56, 58 with the cross member 52. The modification is indicated with a bold line in FIG. 3C, which further illustrates exemplary locations for application of the adhesives 10, 14 on the side member 56 and the cross member 52. As can be seen, both members 52, 56 have a structural contact area 60. The side member 56 has an end portion 62. The top cross member 52 includes tabs 64 within which the side member's end portion 62 nests. The fast-cure adhesive 10 is applied to the end portion 62 of the side member 56 and to the cross member 52 in the vicinity of the tab 64, and/or adjacent to the structural contact area 60. The high-strength adhesive 14 may be applied to the structural contact area 60 of either or both members 52, 56. As was discussed above, both adhesives 10, 14 may be applied to both members, just one of the members, or each member may receive just one of the adhesives 10, 14. For example, when the cross member 52 is the main component to which the side member 56 is being added, both adhesives 10, 14 may be applied to the cross member 52. After both adhesives are applied, the side member 56 is placed in contact with the adhesive layers 16′, pressure is applied, and the fast-cure adhesive 10 is cured within a short time, as was described above. The top cross member 52 is adhesively joined to the left side member 58 in a similar manner.

FIG. 3D depicts an outline of a seat back assembly 50 section including adhesive joints between the left and right side members 56, 58 and the lower cross member 54. The modifications to provide for optimal adhesive attachment of the side member 56 and the lower cross member 54 are depicted in FIG. 3E. The application of the adhesives 10, 14 is similar to the application above with respect to the top cross member 52. The adhesives 10, 14 may be applied to all desirable areas on the one or more members 52, 54, 56, and 58 at the same or different time. After the fast-cure adhesive 10 cures, the green assembly is transferred out of the nest into a curing oven where the conversion of the green assembly into a cured assembly is carried out.

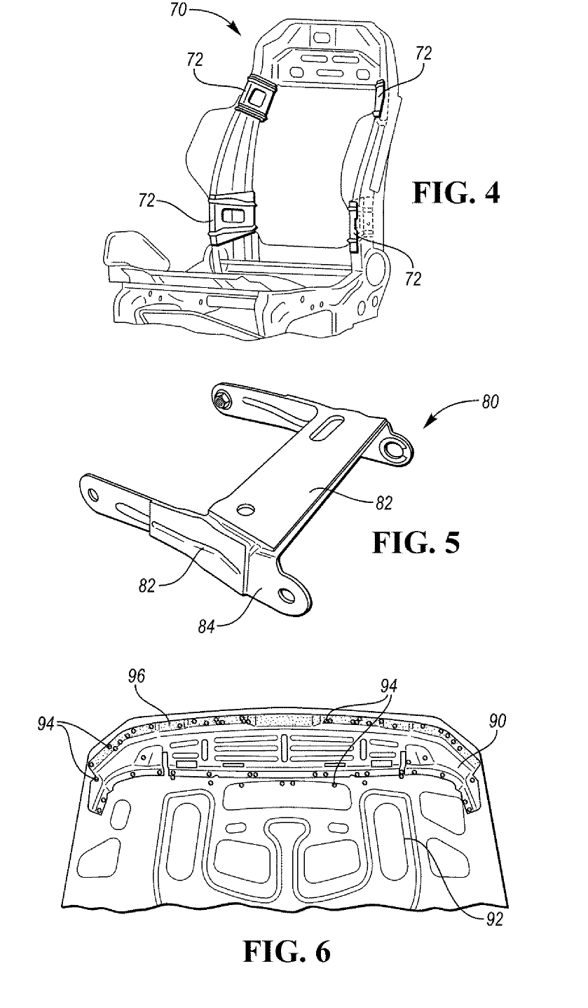

Another example is depicted in FIG. 4 which shows a seat structure 70 with brackets 72 which are joined to the seat structure 70 via the hybrid adhesive system including the fast-cure adhesive 10 and the high-strength adhesive 14 disclosed herein. The brackets 72 provide sufficient reinforcement of the seat structure 70 such that a standard seat structure may become suitable for race track applications.

A yet alternative bracket 80 is disclosed in FIG. 5 which depicts an example reinforced bracket 80 for automotive applications. The bracket includes multiple example plates 82 of sheet metal applied onto the base structure 84 of the bracket. The plates 82 are attached to the base structure 84 with the fast-cure adhesive 10 and the high-strength adhesive 14. The adhesively joined plates 82 may be used to add a strengthening layer of stiff material to a variety of parts which are relatively weak and for which an increase in material thickness of the base structure would result in an addition of excessive weight, which may be undesirable. The adhesive system may not only speed up production, as was described above, but may also contribute to weight reduction of the parts and thus potentially increase fuel efficiency of the target vehicle. The weight reduction may be up to 10%, 15%, 20%, 25%, 30%, 40%, 50% or more when compared to a part designed to meet set strength requirements by increasing material thickness of the base structure. The weight reduction is applicable to other assemblies besides the herein described bracket.

Another example component is depicted in FIG. 6 which shows a front edge stamping 90 for automotive applications. The front edge stamping 90 is placed between a car hood skin (not depicted) and a lower side reinforcement of the hood 92. The dual hybrid adhesive system described herein may be used to adhesively join the front edge stamping 90 with the lower side reinforcement of the hood 92. The areas 94 depict traditional weld locations where the fast-cure adhesive 10 and the high-strength adhesive 14 may be applied instead of welding. The fast-cure adhesive 10 and the high-strength adhesive 14 could be applied as a continuous, semi-continuous, or discontinuous layer 96 between the two parts: the front edge stamping 90 and the lower side reinforcement of the hood 92. The depicted layer 96 is just an illustrative non-limiting example. The extent, dimensions, and location of the layer 96 may differ from what is depicted.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A metal or composite component assembly comprising:
a first metal or composite component;
a second metal or composite component; and
an adhesive layer arranged on an interface of the first and second components and bonding the first and second components, the adhesive layer comprising a fast-cure low-strength adhesive and a high-strength structural adhesive.

2. The assembly of claim 1, wherein the high-strength structural adhesive cures at a temperature greater than the fast-cure adhesive.

3. The assembly of claim 1, wherein the high-strength structural adhesive cures slower than the fast-cure adhesive.

4. The assembly of claim 1, wherein the fast-cure adhesive is arranged in a plurality of areas spaced apart from each other within the layer.

5. The assembly of claim 4, wherein at least one of the areas is about 10 mm in diameter.

6. The assembly of claim 4, wherein the plurality of areas represents about 10% of the adhesive layer surface area.

7. The assembly of claim 1, wherein the fast-cure adhesive bonds the first and second components with a tensile strength of about 6.9 MPa or more measured according to ISO 6922 within about 10 seconds after application at ambient temperatures.

8. The assembly of claim 1, wherein the high-strength structural adhesive has a post-cure tensile strength greater than 30 MPa.

9. The assembly of claim 1, wherein at least one of the first and second components comprises steel.

10. A metal or composite assembly comprising:
a first member having a structural contact area and an end portion; and
a second member adhesively joined to the first member with a first bond formed by a fast-cure low-strength adhesive between the end portion of the first member and the second member and a second bond formed by a high-strength adhesive between the structural contact area of the first member and the second member.

11. The assembly of claim 10, wherein the assembly is a suspension member assembly.

12. The assembly of claim 10, wherein the first and second members comprise a same metal.

13. The assembly of claim 10, wherein at least the first member comprises a carbon fiber composite.

14. The assembly of claim 10, wherein the high-strength adhesive cures slower than the fast-cure low-strength adhesive.

15. A process of forming a metal or composite assembly comprising:
applying a fast-cure low-strength adhesive and a high-strength adhesive to a first component, a second component, or both;
pressing the second component onto the first component to form an assembly; and
removing the assembly from a nest such that the fast-cure low-strength adhesive provides sufficient tack to keep the first and second components joined at least until the high-strength adhesive cures after removal of the assembly from the nest.

16. The process of claim 15, wherein a cycle time of the process is less than 60 seconds.

17. The process of claim 15, further comprising removing the assembly from the nest within about 10 seconds after the fast-cure low-strength adhesive application.

18. The process of claim 15, wherein the high-strength adhesive is a slow-cure or high temperature-cure adhesive.

19. The process of claim 15, further comprising curing the high-strength adhesive in an oven for about 15 to 60 minutes at a temperature of about 180° C.

20. The process of claim 15, further comprising applying the fast-cure low-strength adhesive to a plurality of target areas large enough to provide a non-creeping, non-fracturing bond after the assembly is removed from a nest.
